(19) United States
(12) Patent Application Publication
(10) Pub. No.: US 2021/0332883 A1
(43) Pub. Date: Oct. 28, 2021

(54) METHOD OF MANUFACTURING DRIVING DRUM

(71) Applicant: TOYOTA JIDOSHA KABUSHIKI KAISHA, Toyota-shi (JP)

(72) Inventor: Kazuhiro TOYAMA, Toyota-shi (JP)

(73) Assignee: TOYOTA JIDOSHA KABUSHIKI KAISHA, Toyota-shi (JP)

(21) Appl. No.: 17/201,209

(22) Filed: Mar. 15, 2021

(30) Foreign Application Priority Data
Apr. 23, 2020 (JP) 2020-076484

(51) Int. Cl. F16H 63/18; F16H 61/32

(52) U.S. Cl. CPC F16H 63/18; F16H 2061/2869; F16H 61/32

(57) ABSTRACT

A first cylindrical member including protrusions on an end face is formed in an axial direction, the end face having projections and recesses in the axial direction so as to correspond to cam profiles of first and second cam grooves, a second cylindrical member having an end face having projections and recesses so as to correspond to the projections and the recesses of the first cylindrical member is formed, and at a position where the projections and the recesses of the first cylindrical member correspond to the projections and the recesses of the second cylindrical member, the protrusions of the first cylindrical member are joined to the end face of the second cylindrical member, to thereby form the first cam groove on an inner side of the protrusions in the circumferential direction and form the second cam groove on an outer side of the protrusions in the circumferential direction.

### CROSS REFERENCE TO RELATED APPLICATIONS

This application is based upon and claims the benefit of priority from Japanese patent application No. 2020-076484, filed on Apr. 23, 2020, the disclosure of which is incorporated herein in its entirety by reference.

### BACKGROUND

The present disclosure relates to a method of manufacturing a driving drum for a shift mechanism.

A shift mechanism is known which includes: a driving drum that is disposed on a rotational axis in a rotatable manner, has a cylindrical shape, has a first cam groove formed on an inner circumferential surface in a circumferential direction thereof and a second cam groove formed on an outer circumferential surface in a circumferential direction thereof; a first driven drum that engages with the first cam groove and moves along the rotational axis in accordance with the rotation of the driving drum; and a second driven drum that engages with the second cam groove and moves along the rotational axis in accordance with the rotation of the driving drum (for example, see Japanese Unexamined Patent Application Publication No. 2019-194493).

### SUMMARY

In manufacturing the driving drum for the shift mechanism mentioned above, for example, the first and second cam grooves are formed by performing a process for cutting the inner circumferential surface and the outer circumferential surface, respectively, of a cylindrical member by using a cutting tool. However, although the process for cutting the outer circumferential surface is relatively easy, the process for cutting the inner circumferential surface is more laborious since the interference between the cutting tool and the member needs to be considered. Accordingly, a manufacturing time of the driving drum tends to increase.

The present disclosure has been made in order to solve the problem mentioned above and a main object is to provide a method of manufacturing a driving drum by which a driving drum can be manufactured in a short time.

An aspect of the present disclosure for achieving the aforementioned object is a method of manufacturing a driving drum disposed on a rotational axis in a rotatable manner, the driving drum having a cylindrical shape, and including a first cam groove formed on an inner circumferential surface in a circumferential direction thereof and a second cam groove formed on an outer circumferential surface in a circumferential direction thereof, the method including:

forming a first cylindrical member including a plurality of protrusions on an end face thereof, each of the plurality of the protrusions protruding in an axial direction thereof, the end face having projections and recesses in the axial direction thereof so as to correspond to cam profiles of the first and the second cam grooves;

forming a second cylindrical member having an end face having projections and recesses in an axial direction thereof so as to correspond to the projections and the recesses of the end face of the first cylindrical member; and

at a position where the projections and the recesses of the end face of the first cylindrical member correspond to the projections and the recesses of the end face of the second cylindrical member, joining each of the protrusions of the first cylindrical member to the end face of the second cylindrical member, thereby forming the first cam groove on an inner side of each of the protrusions in the circumferential direction thereof and forming the second cam groove on an outer side of each of the protrusions in the circumferential direction thereof by means of the end faces of the first and the second cylindrical members.

According to the aspect, a through hole may be formed on the end face of the second cylindrical member in the axial direction thereof, the end face being joined to the protrusions of the first cylindrical member, and after the first cylindrical member is positioned on the second cylindrical member, a brazing material may be set in the through hole of the second cylindrical member, and in a sintering process, the brazing material set in the through hole of the second cylindrical member may be melted at the same time as the first and the second cylindrical members are baked and hardened, to thereby braze each of the protrusions of the first cylindrical member to the end face of the second cylindrical member.

According to the aspect, in accordance with a rotation of the driving drum, a first driven drum having a first follower pin that engages with the first cam groove may move along the rotational axis and a second driven drum having a second follower pin that engages with the second cam groove may move along the rotational axis, a plurality of outer groove parts may be formed on an outer circumferential surface of the first cylindrical member, each of the plurality of the outer groove parts extending in the axial direction thereof so as to correspond to a position of the second follower pin of the second driven drum, and a plurality of inner groove parts may be formed on an inner circumferential surface of the first cylindrical member, each of the plurality of the inner groove parts extending in the axial direction thereof so as to correspond to a position of the first follower pin of the first driven drum.

According to the present disclosure, a method of manufacturing a driving drum by which a driving drum can be manufactured in a short time can be provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a sectional diagram showing a schematic structure of a shift mechanism;

FIG. 2 is a perspective diagram showing a schematic structure of a driving drum;

FIG. 3 is a perspective diagram showing a schematic structure of a first driven drum;

FIG. 4 is a perspective diagram showing a schematic structure of a second driven drum;

FIG. 5 shows perspective diagrams of a first cylindrical member, a second cylindrical member, and the driving drum according to an embodiment;

FIG. 6 is a flowchart showing a flow of a method of manufacturing the driving drum according to the embodiment;

FIG. 7 is a diagram for explaining the method of manufacturing the driving drum according to the embodiment; and

FIG. 8 is a diagram for explaining another method of manufacturing the driving drum.

### DESCRIPTION OF EMBODIMENTS

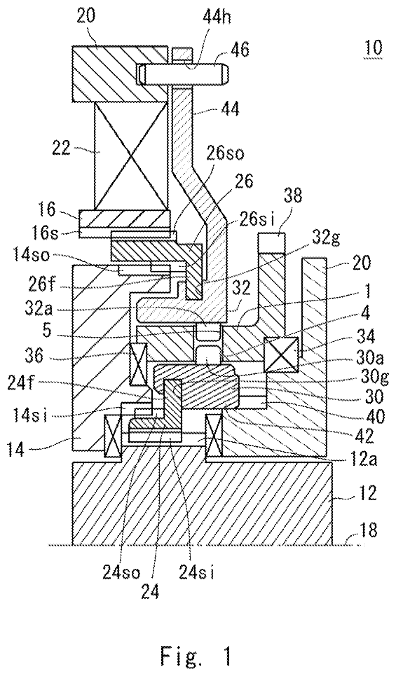

A driving drum according to an embodiment of the present disclosure is mounted on a shift mechanism for a power transmission apparatus. FIG. 1 is a sectional diagram showing a schematic structure of the shift mechanism. A shift mechanism 10 is a mechanism that switches a power transmission path among a first transmission shaft 12, a second transmission shaft 14, and a third transmission shaft 16.

The first to the third transmission shafts 12, 14, and 16 are coaxially disposed around a rotational axis 18 in a rotatable manner. In FIG. 1, parts that are disposed below the rotational axis 18 are omitted since they are formed in a manner substantially similar to the manner that the parts that are disposed above the rotational axis 18 are formed. The first transmission shaft 12 is disposed at an innermost position. The second transmission shaft 14 is disposed so that it surrounds the first transmission shaft 12. The third transmission shaft 16 is disposed on further outer side so that it surrounds the first and second transmission shafts 12 and 14. The first to third transmission shafts 12, 14, and 16 are supported by a case 20 in a rotatable manner.

The state in which the first transmission shaft 12 and the second transmission shaft 14 are connected or disconnected (hereinafter referred to as a connected/disconnected state) is switched by the movement of a first shift sleeve 24 in a direction along the rotational axis 18 (hereinafter referred to as a rotational axis direction). The connected/disconnected state between the second transmission shaft 14 and the third transmission shaft 16 is switched by the movement of a second shift sleeve 26 in the rotational axis direction. Both the first and second shift sleeves 24 and 26 have an annular shape and are coaxially disposed with respect to the rotational axis 18.

A spline 12s is formed on an outer circumferential surface of the first transmission shaft 12. An inner circumferential spline 24si that engages with the spline 12s of the first transmission shaft 12 is formed on an inner circumferential surface of the first shift sleeve 24. The first shift sleeve 24 rotates integrally with the first transmission shaft 12 when the spline 12s of the first transmission shaft 12 and the inner circumferential spline 24si of the first shift sleeve 24 are engaged with each other.

The first shift sleeve 24 is movable above the spline 12s of the first transmission shaft 12 in the rotational axis direction. The engaged state between the spline 12s and the inner circumferential spline 24si is maintained within the moving range of the first shift sleeve 24. An annular outward flange 24f is disposed on the outer circumferential surface of the first shift sleeve 24.

An inner circumferential spline 14si is formed on an inner circumferential surface of the second transmission shaft 14. An outer circumferential spline 24so capable of engaging with the inner circumferential spline 14si of the second transmission shaft 14 is formed on the outer circumferential surface of the first shift sleeve 24. The engaged state between the outer circumference spline 24so of the first shift sleeve 24 and the inner circumference spline 14si of the second transmission shaft 14 is switched depending on the position of the first shift sleeve 24 in the rotational axis direction.

When the first shift sleeve 24 moves toward the second transmission shaft 14, the outer circumference spline 24so and the inner circumference spline 14si engage with each other. Owing to this engagement, the second transmission shaft 14 rotates integrally with the first transmission shaft 12 through the first shift sleeve 24. On the other hand, when the first shift sleeve 24 separates from the second transmission shaft 14, the engagement between the outer circumferential spline 24so and the inner circumferential spline 14si is released, and the second transmission shaft 14 becomes rotatable about the first transmission shaft 12.

A spline 16s is formed on an inner circumferential surface of the third transmission shaft 16. An outer circumferential spline 26so that engages with the spline 16s of the third transmission shaft 16 is formed on the outer circumferential surface of the second shift sleeve 26. The second shift sleeve 26 rotates integrally with the third transmission shaft 16 when the spline 16s of the third transmission shaft 16 and the outer circumferential spline 26so of the second shift sleeve 26 are engaged with each other.

The second shift sleeve 26 is movable above the spline 16s of the third transmission shaft 16 in the rotational axis direction. The engaged state between the spline 16s and the outer circumferential spline 24so is maintained within the moving range of the second shift sleeve 26. An annular inward flange 26f is disposed on an inner circumferential surface of the second shift sleeve 26.

An outer circumferential spline 14so is formed on the outer circumferential surface of the second transmission shaft 14. An inner circumferential spline 26si capable of engaging with the outer circumferential spline 14so of the second transmission shaft 14 is formed on the inner circumferential surface of the second shift sleeve 26. The engaged state between the inner circumferential spline 26si of the second shift sleeve 26 and the outer circumferential spline 14so of the second transmission shaft 14 is switched depending on the position of the second shift sleeve 26 in the rotational axis direction.

When the second shift sleeve 26 moves toward the second transmission shaft 14, the inner circumferential spline 26si and the outer circumferential spline 14so engage with each other. Owing to this engagement, the third transmission shaft 16 rotates integrally with the second transmission shaft 14 through the second shift sleeve 26. On the other hand, when the second shift sleeve 26 separates from the second transmission shaft 14, the engagement between the inner circumferential spline 26si and the outer circumferential spline 14so is released, and the third transmission shaft 16 becomes rotatable about the second transmission shaft 14.

The shift mechanism 10 further includes a driving drum 1, a first driven drum 30, and a second driven drum 32 that move the first shift sleeve 24 and the second shift sleeve 26 in the rotational axis direction. The driving drum 1, the first driven drum 30, and the second driven drum 32 are coaxially disposed on the rotational axis 18.

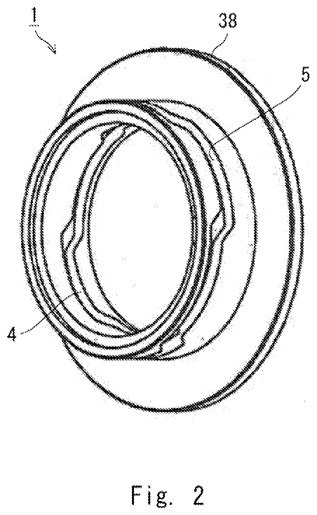

FIG. 2 is a perspective diagram showing a schematic structure of the driving drum. In FIG. 2, teeth of a gear 38 are omitted for the sake of simplifying the figure. The driving drum 1 is disposed on the rotational axis 18 in a rotatable manner and has a cylindrical shape. A first cam groove 4 is formed on an inner circumferential surface of the driving drum 1 in a circumferential direction thereof. A second cam groove 5 is formed on an outer circumferential surface of the driving drum 1 in the circumferential direction thereof.

The driving drum 1 is supported by bearings 34 and 36 in a rotatable manner with respect to the case 20. The driving drum 1 has the gear 38 such as a spur gear, a helical gear, or the like. The gear 38 engages with a pinion (not shown) fixed to an output shaft of a shift motor (not shown). The driving drum 1 can be rotated by the shift motor.

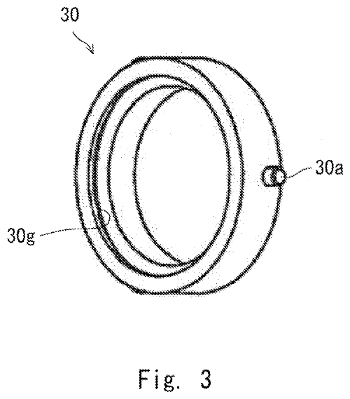

FIG. 3 is a perspective diagram showing a schematic structure of the first driven drum. The first driven drum 30 includes, on its outer circumferential surface, a first follower pin 30a that engages with the first cam groove 4. The first driven drum 30 moves along the rotational axis 18 as the first follower pin 30a follows the first cam groove 4 of the driving drum 1 when the driving drum 1 rotates.

The first driven drum 30 is positioned on the inner circumference side of the driving drum 1 and the first shift sleeve 24 is positioned on the inner circumference side of the first driven drum 30. The first driven drum 30 includes an inner circumferential spline 42 that engages with an outer circumferential spline 40 formed in the case 20.

The first driven drum 30 is prevented from rotating about the case 20, that is, its movement in the rotational direction is restrained by the outer and the inner circumferential splines 40 and 42. Meanwhile, the movement of the first driven drum 30 in the rotational axis direction is permitted. The outer and inner circumferential splines 40 and 42 may be replaced by a detent key and a key groove, respectively.

A holding groove 30g extending in the circumferential direction is disposed on an inner circumferential surface of the first driven drum 30, and the holding groove 30g holds the outward flange 24f of the first shift sleeve 24 in the groove. By this structure, the first driven drum 30 and the first shift sleeve 24 move along the rotational axis 18.

Meanwhile, the first shift sleeve 24 can rotate in the rotational direction independently of the first driven drum 30. The outward flange 24f of the first shift sleeve 24 can be replaced by a plurality of projections arranged in the circumferential direction.

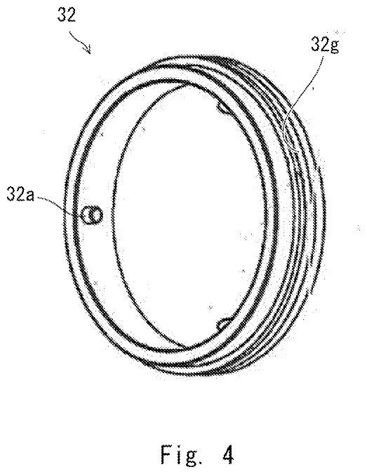

FIG. 4 is a perspective diagram showing a schematic structure of the second driven drum. The second driven drum 32 includes, on its inner circumferential surface, a second follower pin 32a that engages with the second cam groove 5. The second driven drum 32 moves along the rotational axis 18 as the second follower pin 32a follows the second cam groove 5 of the driving drum 1 when the driving drum 1 rotates.

The second driven drum 32 is positioned on the outer circumference side of the driving drum 1 and the second shift sleeve 26 is positioned on the outer circumference side of the second driven drum 32. The second driven drum 32 has a detent arm 44 extending outwardly in a radial direction.

A receiving hole 44h that receives a detent pin 46 fixed to the case 20 is formed on the detent arm 44. The detent pin 46 is received by the receiving hole 44h and is engaged with the detent arm 44. By this structure, the second driven drum 32 is prevented from rotating about the case 20, that is, its movement in the rotational direction is restrained.

Meanwhile, its movement in the rotational axis direction is permitted. The detent arm 44 and the detent pin 46 may be disposed at one position or at plurality of positions in the circumferential direction.

A holding groove 32g extending in the circumferential direction is disposed on the outer circumferential surface of the second driven drum 32. The holding groove 32g holds the inward flange 26f of the second shift sleeve 26 in the groove. By this structure, the second driven drum 32 and the second shift sleeve 26 move along the rotational axis 18.

Meanwhile, the second shift sleeve 26 can rotate in the rotational direction independently of the second driven drum 32. The inward flange 26f of the second shift sleeve 26 can be replaced by a plurality of projections arranged in the circumferential direction.

Next, a relationship among the driving drum 1, the first driven drum 30, and the second driven drum 32 is explained in detail. The first cam groove 4 and the second cam groove are formed on the inner circumferential surface and the outer circumferential surface, respectively, of a cylindrical part of the driving drum 1.

The first cam groove 4 extends substantially in the circumferential direction and has a cam profile having projections and recesses in the rotational axis direction. The first cam groove 4 has, for example, a cam profile of three cycles. The first follower pin 30a of the first driven drum 30 is engaged with the first cam groove 4. Three first follower pins 30a are disposed at regular intervals so as to correspond to the cam profile of the first cam groove 4 having three cycles.

The second cam groove 5 extends substantially in the circumferential direction and has a cam profile having projections and recesses in the rotational axis direction. The second cam groove 5 has, for example, a cam profile of three cycles. The second follower pin 32a of the second driven drum 32 is engaged with the second cam groove 5. Three second follower pins 32a are disposed at regular intervals so as to correspond to the cam profile of the second cam groove 5 having three cycles. The cam profiles of the first and second cam grooves 4 and 5 are the same as each other.

When the driving drum 1 rotates, the first and the second follower pins 30a and 32a follow the cam profiles of the first and the second cam grooves 4 and 5, and accordingly, the first and the second driven drums 30 and 32 move in the rotational axis direction. The timing at which the first and the second driven drums 30 and 32 move is determined according to the cam profiles of the first and the second cam grooves 4 and 5 and the positions of the first and the second follower pins 30a and 32a in the circumferential direction.

When the first driven drum 30 moves toward the second transmission shaft 14, that is, moves leftward in FIG. 1, the first shift sleeve 24 also moves toward the second transmission shaft 14, and the outer circumferential spline 24so of the first shift sleeve 24 engages with the inner circumferential spline 14si of the second transmission shaft 14. Accordingly, the first and the second transmission shafts 12 and 14 are connected to each other and brought to a connected state.

When the first driven drum 30 moves in the opposite direction, that is, in the rightward direction in FIG. 1, the engagement between the outer and the inner circumferential splines 24so and 14si is released, and the first and the second transmission shafts 12 and 14 are separated from each other and brought to a disconnected state. As described above, the connected/disconnected state between the first and the second transmission shafts 12 and 14 is switched by the movement of the first driven drum 30 in the direction of the rotational axis 18.

When the second driven drum 32 moves toward the second transmission shaft 14, that is, moves leftward in FIG. 1, the second shift sleeve 26 also moves toward the second transmission shaft 14, and the inner circumferential spline 26si of the second shift sleeve 26 engages with the outer circumferential spline 14so of the second transmission shaft 14. Accordingly, the second and the third transmission shafts 14 and 16 are connected to each other and brought to a connected state.

When the second driven drum 32 moves in the opposite direction, that is, in the rightward direction in FIG. 1, the engagement between the inner and the outer circumferential splines 26si and 14so is released. Accordingly, the second and the third transmission shafts 14 and 16 are brought to a disconnected state. As described above, the connected/disconnected state between the second and the third transmission shafts 14 and 16 is switched by the movement of the second driven drum 32 in the rotational axis direction.

In a state in which both of the first and the second driven drums 30 and 32 have moved toward the second transmission shaft 14, the first and the third transmission shafts 12 and 16 are brought to a state in which they are connected to each other via the second transmission shaft 14. Accordingly, the first to the third transmission shafts 12, 14, and 16 become integrally rotatable.

In a state in which the first driven drum 30 has moved toward the second transmission shaft 14 and the second driven drum 32 has been separated from the second transmission shaft 14, the first and the second transmission shafts 12 and 14 are connected with each other. By this connection, the third transmission shaft 16 becomes relatively rotatable with respect to the first and the second transmission shafts 12 and 14.

In a state in which the first driven drum 30 has been separated from the second transmission shaft 14 and the second driven drum 32 has moved toward the second transmission shaft 14, the second and the third transmission shafts 14 and 16 are connected with each other. By this connection, the first transmission shaft 12 becomes relatively rotatable with respect to the second and the third transmission shafts 14 and 16. In a state in which both of the first and the second driven drums 30 and 32 have been separated from the second transmission shaft 14, the first to the third transmission shafts 12, 14, and 16 are separated from each other and they become rotatable independently of each other. Note that the structure and the like of the shift mechanism 10 described above are disclosed in detail in Japanese Patent Application No. 2018-086858 which has been already filed by the applicant of the present disclosure, and they can be employed in the present disclosure.

Meanwhile, in manufacturing the driving drum for the shift mechanism described above, conventionally, the first and the second cam grooves are formed by performing a process for cutting the inner circumferential surface and the outer circumferential surface, respectively, of the cylindrical member by using a cutting tool. However, although the process for cutting the outer circumferential surface is relatively easy, the process for cutting the inner circumferential surface is more laborious since the interference between the cutting tool and the member needs to be considered. Accordingly, manufacturing time of the driving drum tends to increase. Specifically, since the first cam groove is formed on the inner circumferential surface and is formed as one circle composed of continuous curved line, its processing is difficult and its manufacturing cost is high.

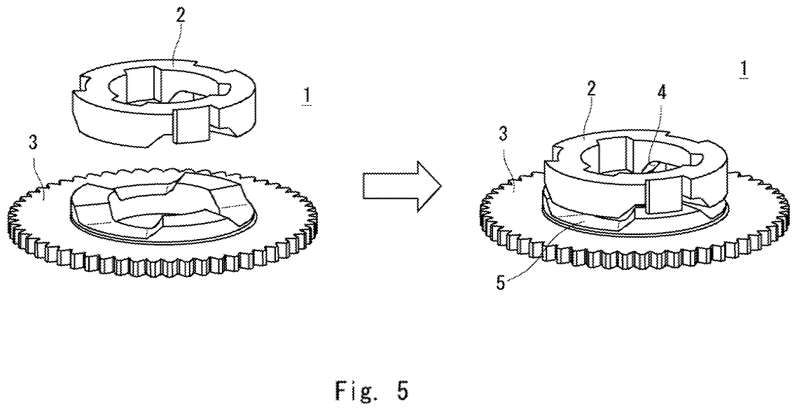

In contrast to this, in the method of manufacturing the driving drum 1 according to this embodiment, as shown in FIG. 5, each of a first cylindrical member 2 and a second cylindrical member 3 is molded and the molded first and second cylindrical members 2 and 3 are combined with each other, so that the first cam groove 4 and the second cam groove 5 are formed on the inner circumferential surface and the outer circumferential surface, respectively, of the cylindrical part of the driving drum 1.

Therefore, there is no need to perform the process for cutting the inner surface and the outer circumferential surface, respectively, of the cylindrical member by using the cutting tool, and the driving drum 1 can be manufactured by a simple method of separately molding the first and the second cylindrical members 2 and 3 and combining the molded first and second cylindrical members 2 and 3 with each other. Accordingly, the driving drum 1 can be manufactured in a short time.

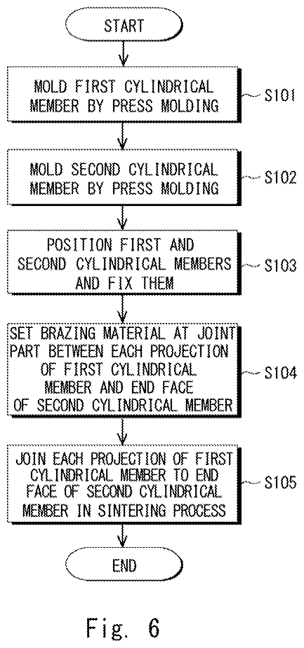

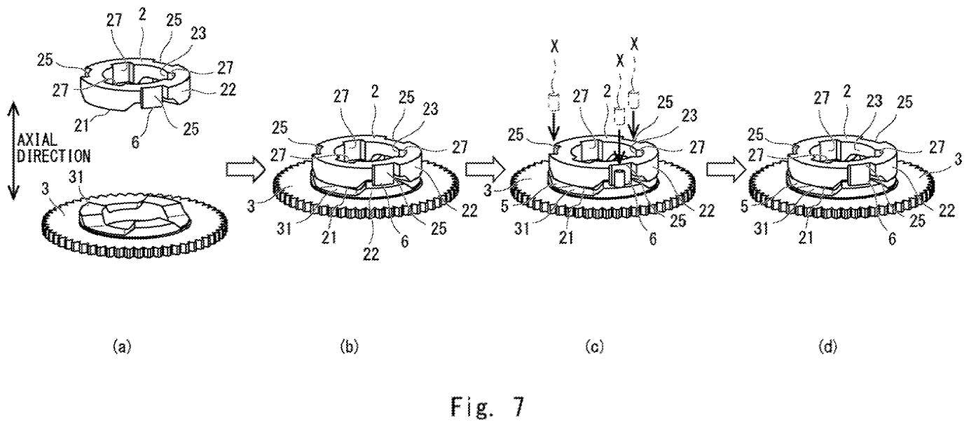

FIG. 6 is a flowchart showing a flow of the method of manufacturing the driving drum according to this embodiment. FIG. 7 is a diagram for explaining the method of manufacturing the driving drum according to this embodiment.

First, the first cylindrical member 2 having a cylindrical shape is powder-molded by employing press molding or the like ((a) of FIG. 7) (Step S101).

The first cylindrical member 2 is formed in such a way that an end face 21 thereof has projections and recesses in the axial direction so as to correspond to the cam profiles of the first and the second cam grooves 4 and 5. For example, three protrusions 6 that protrude in the axial direction are formed on the end face of the first cylindrical member 2 at regular intervals in the circumferential direction, but the structure of the protrusions 6 is not limited to this. The number of protrusions 6 formed on the end face 21 of the first cylindrical member 2 may be three or more, and they may be formed at any positions.

Each of the protrusions 6 is formed so that it becomes thinner in an inward direction with respect to an outer circumferential surface 22 of the first cylindrical member 2. This structure forms the second cam groove 5 on an outer side of each of the protrusions 6 in the circumferential direction. A rotation of the driving drum 1 relative to the second driven drum 32 enables the second follower pin 32a to pass through the outer side of each of the protrusions 6 by the second cam groove 5.

Each of the protrusions 6 is formed so that it becomes thinner in an outward direction with respect to an inner circumferential surface 23 of the first cylindrical member 2. This structure forms the first cam groove 4 on an inner side of each of the protrusions 6 in the circumferential direction. A rotation of the driving drum 1 relative to the first driven drum 30 enables the first follower pin 30a to pass through the inner side of each of the protrusions 6 by the first cam groove 4.

Three outer groove parts 25 extending in the axial direction are formed on the outer circumferential surface 22 of the first cylindrical member 2 so as to respectively correspond to the positions of the three second follower pins 32a of the second driven drum 32. When the second driven drum 32 is assembled in the drive drum 1 in the axial direction, the second follower pins 32a pass through the respective outer groove parts 25 and reach the second cam groove 5. As described above, the outer groove parts 25 are formed on the outer circumferential surface 22 of the first cylindrical member 2, whereby it is possible to easily assemble the second driven drum 32 in the drive drum 1 by simply inserting it into the drive drum 1 in the axial direction.

Note that the outer groove parts 25 may not be formed on the outer circumferential surface 22 of the first cylindrical member 2. In this case, the second driven drum 32 is assembled in the drive drum 1, and then the second follower pin 32a may be assembled in the second driven drum 32.

Three inner groove parts 27 extending in the axial direction are formed on the inner circumferential surface 23 of the first cylindrical member 2 so as to respectively correspond to the positions of the three first follower pins 30a of the first driven drum 30. When the first driven drum 30 is assembled in the drive drum 1 in the axial direction, the first follower pins 30a pass through the respective inner groove parts 27 and reach the first cam groove 4. As described above, the inner groove part 27 is formed on the inner circumferential surface 23 of the first cylindrical member 2, whereby it is possible to easily assemble the first driven drum 30 in the drive drum 1 by only inserting it into the drive drum 1 in the axial direction.

Note that the inner groove part 27 may not be formed on the inner circumferential surface 23 of the first cylindrical member 2. In this case, the first driven drum 30 is assembled in the drive drum 1, and then the first follower pin 30a may be assembled in the first driven drum 30.

The second cylindrical member 3 having a cylindrical shape is powder-molded by employing press molding or the like ((a) of FIG. 7) (Step S102).

The second cylindrical member 3 is formed in such a way that an end face 31 thereof has projections and recesses in the axial direction so as to correspond to the cam profiles of the first and the second cam grooves 4 and 5. Therefore, the end face 31 of the second cylindrical member 3 has the projections and the recesses so as to correspond to projections and recesses of the end face 21 of the first cylindrical member 2.

The first and the second cylindrical members 2 and 3 are positioned so that the projections and the recesses of the end face 21 of the first cylindrical member 2 correspond to the projections and the recesses of the end face 31 of the second cylindrical member 3, and then the first and the second cylindrical members 2 and 3 are fixed in a state where each of the protrusions 6 of the first cylindrical member 2 are brought into contact with the end face 31 of the second cylindrical member 3 ((b) of FIG. 7) (Step S103).

Positioning grooves into which the tips of the protrusions 6 of the first cylindrical member 2 are respectively fitted may be formed on the end face 31 of the second cylindrical member 3. Thus, by these positioning grooves, it is possible to easily position the first cylindrical member 2 on the second cylindrical member 3. Note that the positioning grooves may not be formed on the end face 31 of the second cylindrical member 3. In this case, a mark for the positioning is attached to each of the first and the second cylindrical members 2 and 3, and the first cylindrical member 2 may be positioned on the second cylindrical member 3 by aligning the marks with each other.

In a state where the first and the second cylindrical members 2 and 3 are fixed, a brazing material X is set at a joint part between each protrusion 6 of the first cylindrical member 2 and the end face 31 of the second cylindrical member 3 ((c) of FIG. 7) (Step S104). The brazing material X may be set, for example, in the aforementioned positioning groove.

The first and the second cylindrical members 2 and 3 are baked and hardened in a sintering process. In this sintering process, the brazing material X set at the joint part between each protrusion 6 of the first cylindrical member 2 and the end face 31 of the second cylindrical member 3 is melted, the brazing material X is allowed to penetrate into the joint part between each protrusion 6 of the first cylindrical member 2 and the end face 31 of the second cylindrical member 3, and then each protrusion 6 of the first cylindrical member 2 and the end face 31 of the second cylindrical member 3 are joined to each other ((d) of FIG. 7) (Step S105).

In this way, by means of the end face 21 of the first cylindrical member 2 and the end face 31 of the second cylindrical member 3, the first cam groove 4 is formed on the inner side of each of the protrusions 6 in the circumferential direction, and the second cam groove 5 is formed on the outer side of each of the protrusions 6 in the circumferential direction.

As described above, in the method of manufacturing the driving drum according to this embodiment: the first cylindrical member 2 including a plurality of protrusions 6 on the end face 21 thereof is formed, each of the plurality of the protrusions 6 protruding in the axial direction thereof, the end face 21 having projections and recesses in the axial direction thereof so as to correspond to the cam profiles of the first and the second cam grooves 4 and 5; the second cylindrical member 3 having the end face 31 having projections and recesses in the axial direction thereof so as to correspond to the projections and the recesses of the end face 21 of the first cylindrical member 2 is formed; and at a position where the projections and the recesses of the end face 21 of the first cylindrical member 2 correspond to the projections and the recesses of the end face 31 of the second cylindrical member 3, each of the protrusions 6 of the first cylindrical member 2 is joined to the end face 31 of the second cylindrical member 3, to thereby form the first cam groove 4 on the inner side of each of the protrusions 6 in the circumferential direction thereof and form the second cam groove 5 on the outer side of each of the protrusions 6 in the circumferential direction thereof by means of the end face 21 of the first cylindrical member 2 and the end face 31 of the second cylindrical member 3.

Since this structure eliminates the need for the process for cutting the inner and the outer circumferential surfaces, respectively, of the cylindrical member by using a cutting tool, it is possible to manufacture the driving drum 1 by a simple method. Thus, it is possible to manufacture the driving drum 1 in a short time.

Further, as compared to the method of manufacturing a driving drum disclosed in Japanese Unexamined Patent Application Publication No. 2018-11977 in which a first cylindrical member is press-fitted into a second cylindrical member, the method of manufacturing the driving drum 1 according to this embodiment does not need a part where the first and the second cylindrical members 2 and 3 overlap each other in the diameter direction. Therefore, the method of manufacturing the drive drum 1 according to this embodiment has an advantage that the size of the cylindrical part of the drive drum 1 can be reduced.

Several embodiments according to the present disclosure have been explained above. However, these embodiments are shown as examples but are not shown to limit the scope of the disclosure. These novel embodiments can be implemented in various forms. Further, their components/structures may be omitted, replaced, or modified without departing from the scope and spirit of the disclosure. These embodiments and their modifications are included within the scope and the spirit of the disclosure and also included within the scope of the claimed disclosure and its equivalents.

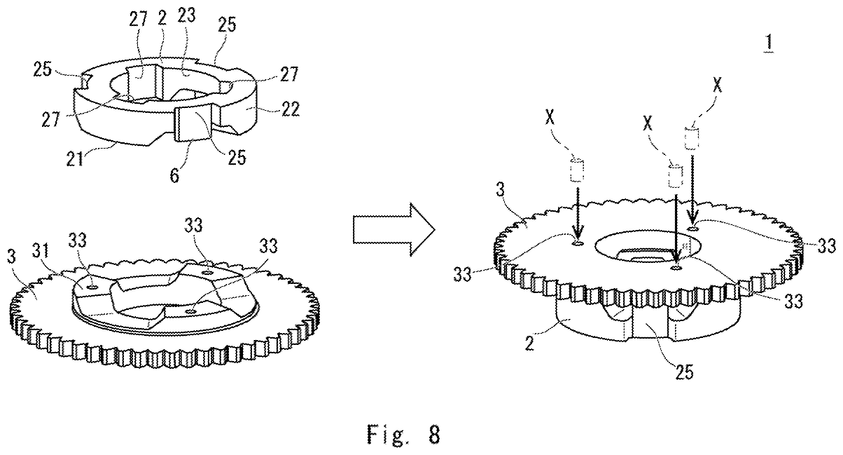

In the aforementioned embodiment, a through hole 33 may be formed on the end face 31 of the second cylindrical member 3 in the axial direction, the end face 31 being joined to the protrusions 6 of the first cylindrical member 2. FIG. 8 is a diagram for explaining another method of manufacturing the driving drum.

For example, after the first cylindrical member 2 is positioned on the second cylindrical member 3, the brazing material X is set in the through hole 33 of the second cylindrical member 3. Then, the first and the second cylindrical members 2 and 3 are baked and hardened in a sintering process. In this sintering process, the brazing material X is melted in the through hole 33 of the second cylindrical member 3, whereby the melted brazing material X penetrates into the joint part between each protrusion 6 of the first cylindrical member 2 and the end face 31 of the second cylindrical member 3, and each protrusion 6 of the first cylindrical member 2 and the end face 31 of the second cylindrical member 3 are brazed to each other.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method of manufacturing a driving drum disposed on a rotational axis in a rotatable manner, the driving drum having a cylindrical shape, and including a first cam groove formed on an inner circumferential surface in a circumferential direction thereof and a second cam groove formed on an outer circumferential surface in a circumferential direction thereof, the method comprising:
forming a first cylindrical member including a plurality of protrusions on an end face thereof, each of the plurality of the protrusions protruding in an axial direction thereof, the end face having projections and recesses in the axial direction thereof so as to correspond to cam profiles of the first and the second cam grooves;
forming a second cylindrical member having an end face having projections and recesses in an axial direction thereof so as to correspond to the projections and the recesses of the end face of the first cylindrical member; and
at a position where the projections and the recesses of the end face of the first cylindrical member correspond to the projections and the recesses of the end face of the second cylindrical member, joining each of the protrusions of the first cylindrical member to the end face of the second cylindrical member, thereby forming the first cam groove on an inner side of each of the protrusions in the circumferential direction thereof and forming the second cam groove on an outer side of each of the protrusions in the circumferential direction thereof by means of the end faces of the first and the second cylindrical members.

2. The method of manufacturing the driving drum according to claim 1, wherein
a through hole is formed on the end face of the second cylindrical member in the axial direction thereof, the end face being joined to the protrusions of the first cylindrical member, and
after the first cylindrical member is positioned on the second cylindrical member, a brazing material is set in the through hole of the second cylindrical member, and in a sintering process, the brazing material set in the through hole of the second cylindrical member is melted at the same time as the first and the second cylindrical members are baked and hardened, to thereby braze each of the protrusions of the first cylindrical member to the end face of the second cylindrical member.

3. The method of manufacturing the driving drum according to claim 1, wherein
in accordance with a rotation of the driving drum, a first driven drum having a first follower pin that engages with the first cam groove moves along the rotational axis and a second driven drum having a second follower pin that engages with the second cam groove moves along the rotational axis,
a plurality of outer groove parts are formed on an outer circumferential surface of the first cylindrical member, each of the plurality of the outer groove parts extending in the axial direction thereof so as to correspond to a position of the second follower pin of the second driven drum, and
a plurality of inner groove parts are formed on an inner circumferential surface of the first cylindrical member, each of the plurality of the inner groove parts extending in the axial direction thereof so as to correspond to a position of the first follower pin of the first driven drum.
